(19) United States
(12) Patent Application Publication
(10) Pub. No.: US 2015/0049222 A1
(43) Pub. Date: Feb. 19, 2015

(54) METHOD OF ELIMINATING COLOR CAST OF IMAGE IN PHOTOGRAPHIC DEVICE

(71) Applicant: ASUSTeK COMPUTER INC., TAIPEI (TW)

(72) Inventors: Po-Yu YEH, TAIPEI (TW); Po-Yin LAI, TAIPEI (TW)

(21) Appl. No.: 14/459,340

(22) Filed: Aug. 14, 2014

(30) Foreign Application Priority Data
Aug. 16, 2013 (TW) 102129506

(51) Int. Cl. H04N 9/64; H04N 9/73

(52) U.S. Cl. CPC H04N 9/646; H04N 9/735
USPC 348/242

(57) ABSTRACT

A method of eliminating a color cast of image in photographic device includes: obtaining a color cast image; determining a color temperature of the color cast image; analyzing a brightness ratio among a first primary color, a second primary color, and a third primary color of the color cast image; choosing one parameter group from a plurality of color cast calibration parameter groups according to the color temperature; calibrating the brightness ratio among the first primary color, the second primary color, and the third primary color of the color cast image via the chosen color cast calibration parameter group.

### CROSS-REFERENCE TO RELATED APPLICATION

This application claims the priority benefit of Taiwan application No. 102129500 filed on Aug. 16, 2013. The entirety of the above-mentioned patent application is hereby incorporated by reference herein and made a part of specification.

### BACKGROUND OF THE INVENTION

1. Field of the Invention

The disclosure relates to a method of eliminating a color cast of an image,

2. Description of the Related Art

Conventionally, agglutinate lenses can be used to a photographic device according, to different demands, the agglutinate lens is formed by adhering at least two lenses with glue. A thickness of the glue between the agglutinate lenses would increase the size of the photographic device. Consequently glue with high index of refraction may he used to decrease the size of the photographic device. However, the image captured by the photographic device easily has a color cast due to the high index of refraction, and the color distortion of the image is generated.

### BRIEF SUMMARY OF THE INVENTION

A method of eliminating a color cast of an image is provided. In an embodiment, the method of eliminating a color cast of an image includes: obtaining a color cast image; determining a color temperature of the color cast image; analyzing a brightness ratio among a first primary color, a second primary color, and a third primary color of the color cast image; choosing one parameter group from a plurality of color cast calibration parameter groups according to the color temperature; calibrating the brightness ratio among the first primary color, the second primary color, and the third primary color of the color cast image via the chosen color cast calibration parameter group.

In sum up, according to embodiments, the brightness ratio of primary colors of a color cast image can be calibrated by the color cast calibration parameter group, so as to eliminate the color east of the color cast image.

### BRIEF DESCRIPTION OF THE DRAWINGS

FIG. 1 is a flow diagram showing a method of eliminating a color cast of an image in an embodiment of; and

FIG. 2 is a flow diagram showing the step 160 of the method in FIG. 1 of eliminating a color cast of an image in an embodiment.

### DETAILED DESCRIPTION OF AN EMBODIMENTS

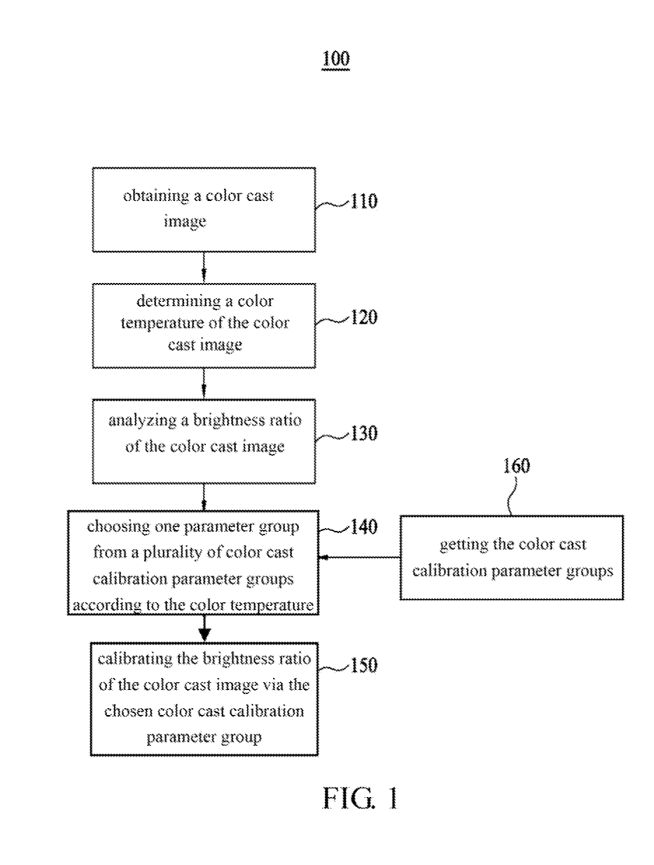

FIG. 1 is a flow diagram showing a method 100 of eliminating a color cast of an image in an embodiment The method 100 of eliminating a color cast of an image can be used in a first photographic device with a color cast.

Detail steps of the method 100 of eliminating a color cast of an image are illustrated hereinafter. Except specifically stated, the order of steps of the method 100 can be adjusted, or executed synchronously or partly synchronously, which is not limited herein.

As shown in step 110, the first photographic device captures a color cast image. In an embodiment, the color cast image includes three primary colors, and in other embodiments, the color cast image may include multiple primary colors, which is not limited herein. Then, as shown in step 120, the first photographic device determines the color temperature of the color cast image. As shown in step 130, the first photographic device analyzes the brightness ratio among a first primary color, a second primary color, and a third primary color of the color cast image.

The first primary color may be red, the second primary color may be green, and the third primary color may be blue. A red color, a green color and a blue color are taken as an example hereinafter. In an embodiment, the first photographic device can get the R/G value of the color cast image by analyzing the brightness ratio between the red color and the green color, and get the B/G value of the color cast image by analyzing the brightness ratio between the blue color and the green color. Wherein the R, G and B represent the brightness ratio of red color, the brightness ratio of green color and the brightness ratio of blue color, respectively. In this embodiment, the step 130 is after the step 120, however, the step 120 and the step 130 can be executed at the same time, or the step 120 is executed after the step 130, the order of the step 120 and step 130 is not limited herein.

After the color temperature of the color cast image is determined, as shown in step 140, the first photographic device chooses one parameter group from multiple color cast calibration parameter groups according to the color temperature. Each of the color cast calibration parameter groups is the calibration parameter of the R/G value and the B/G value in a different color temperature, which can eliminate the color cast in the color temperature and restore the original image. After the color temperature of the color cast image is determined, the first photographic device can choose the color cast calibration parameter group corresponding to the color temperature, such as X value and Y value (the X value is the calibration parameter of the R/G value, and the Y value is the calibration parameter of the B/G value).

As shown in step 150, the first photographic device calibrates the brightness ratio among the red, the green and the blue of the color cast image via the chosen color cast calibration parameter group. In an embodiment, the color cast of the color cast image is eliminated by multiplying the R/G value by the X value and multiplying the B/G value by the Y value. For example, in the color temperature of a fluorescent lamps circumstance, the X value is (0.8/1.1), and the Y value is (0.9/1.2), the R/G value of the color cast image is 1.1, and the B/G value of the color cast image is 1.2. The color cast of the color cast image in the fluorescent lamps circumstance is eliminated by multiplying the R/G value by the X value (that is, 1.1*(0.8/1.1)). The calculation method of X value and Y value would be described hereinafter.

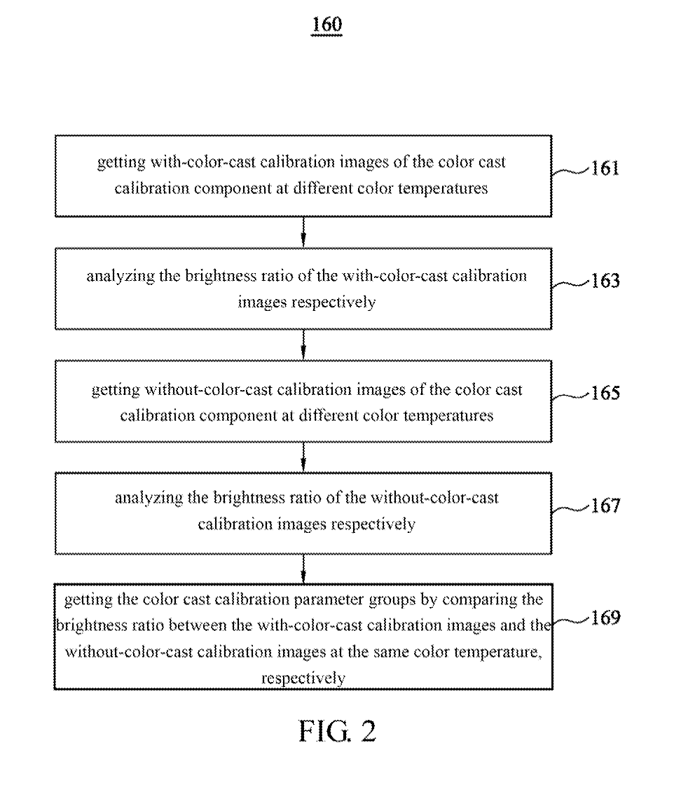

As shown in step 160, before calibrating the color cast image, the first photographic device may further get the color cast calibration parameter groups at different color temperatures, and the detail is described hereinafter. As shown in FIG. 2, FIG. 2 is a flow diagram showing the step 160 of the method in FIG. 1 of eliminating a color cast of an image in an embodiment. Except specifically stated, the order of steps of getting the color cast calibration parameter groups can be adjusted, or executed synchronously or partly synchronously, which is not limited herein.

As shown in step 161, the first photographic device photographs a color cast calibration component at different color temperatures, and gets some with-color-cast calibration images of the color cast calibration component. In an embodiment, the color cast calibration component is a grey card or a white card (such as a 18% grey card). In the case of a white card, the first photographic device gets with-color-cast calibration images by photographing the white card, and the first photographic device may photograph in ambient light of different color temperatures, such as a fluorescent lamps (such as D50/D65), U30, A, H and Cool White, which is not limited herein.

As shown in step 163, the brightness ratio among the red color, the green color and the blue color of the with-color-cast calibration images is analyzed.

In an embodiment, the ambient light is D50 (with a color temperature K1) and Cool White (with a color temperature K2). The brightness ratio between the red color and the green color of the with-color-cast calibration images at the D50 ambient light can be analyzed, and the R1(K1)/G1(K1) value of the with-color-cast calibration images is get; the brightness ratio between the blue color and the green color can be analyzed, and the B1(K1)/G1(K1) value is get, wherein the R1(K1) value, the G1(K1) value and the B1(K1) value represent the brightness ratio of the red color, the green color and the blue color, respectively.

The brightness ratio between the red color and the green color of the with-color-cast calibration images at the U30 ambient light can be analyzed, and the value of R1(K2)/G1(K2) of the with-color-cast calibration images is get; the brightness ratio between the blue color and the green color can be analyzed, and the value of B1(K2)/G1(K2) of the with-color-cast calibration images is get, wherein the values of R1(K2), G1(K2) and B1(K2) represent the brightness ratio of the red color, the green color and the blue color, respectively.

As shown in step 165, a second calibration photographic device without color cast photographs a color cast calibration component at different color temperatures, respectively, and gets without-color-cast calibration images of the color cast calibration component. The second photographic device does not include glue with high index of refraction, and except that the first photographic device includes lenses with glue of high index of refraction, the structure of the second photographic device is substantially the same as the structure of the first photographic device. The second photographic device may photographs in ambient light of different color temperatures such as the light of D50/D65, U30, A, H and Cool White.

After without-color-cast calibration images at different color temperatures are got, as shown in step 167, the brightness ratio between the red color, the green color and the blue color of the without-color-cast calibration images is analyzed. In an embodiment, the light of D50 and cool light are taken as an example. The brightness ratio between the red color and the green color of the without-color-cast calibration images in the D50 ambient light can be analyzed, and the R2(K1)/G2(K1) value of the without-color-cast calibration images is get the brightness ratio between the blue color and the green color can be analyzed, and the B2(K1)/G2(K1) value is get, wherein the R2(k1) value, the G2(K1) value and the B2(K1) value represent the brightness ratio of the red color, the green color and the blue color, respectively.

The brightness ratio between the red color and the green color of the without-color-cast calibration images at the U30 ambient light can be analyzed, and the R2(K2)/G2(K2) value of the without-color-cast calibration images is get; the brightness ratio between the blue color and the green color can be analyzed, and the B2(K2)/G2(K2) value of the without-color-cast calibration images is get, wherein the R2(K2) value, the G2(K2) value and the B2(K2) value represent the brightness ratio of the red color, the green color and the blue color, respectively.

Except specifically stated, the order of steps 161,163 and steps 165,167 can be adjusted, or executed synchronously or partly synchronously, which is not limited herein.

As shown in step 169, the color cast calibration parameter groups are got respectively by comparing, the brightness ratio between the with-color-cast calibration. images and the without-color-cast calibration images at the same color temperature. respectively. For example, the R1(K1)/G1(K1.) value of the with-color-cast calibration. images at the D50 ambient light is 1.1, the R1(K1)/G1(K1) value of the without-color-cast calibration images is 0.8. The color cast of the color cast image can be eliminated, by multiplying the R1(K1)/G1(K1) value by the X(K1) value, that is, 1.1 *X(K1)=0.8, and thus X(K1)=0.8/1.1=(R2(K1)/G2(K1))/(R1(K1)/G1(K1)). Similarly, the Y(K1) value of the color cast calibration parameter group is (B2(K1)/G2(K1))/(B1(K1)/G1(K1)). if the ambient light is Cool. White light, the X(K2) value of the color cast calibration. parameter group is (R2(K2)/G2(K2))/(R1(K2))/G1(K2)), and the Y(K2) value of the color cast calibration parameter group is (B2(K2)/G2(K2))/(B1(K2)/G1(K2)). Thus, after the first photographic device analyzes the color temperature of the color cast image, the color cast calibration parameter group with the same color temperature can be used to correct the image and form the without-color-cast calibration image.

Additionally, color cast calibration parameter groups at other color temperatures can be got by fitting the color cast calibration parameter groups described above. For example, if the ambient light is D50 and Cool White light, the color temperature of the light of D50 is about 5000K, and the color temperature of the light of Cool White is about 4000K. As a result, the X value of the color temperature between 4000K and 5000K can be linear fitted by the X(K1) value and the X(K2) value, and the fitting method is not limited herein. The Y value of the color temperature between 4000K and 5000K can be linear fitted by the Y(K1) value and the Y(K2) value, and the fitting method is not limited herein.

Although the present disclosure has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A method of eliminating a color cast of an image in a photographic device including:
obtaining a color cast image via the photographic device;
determining a color temperature of the color cast image;
analyzing a brightness ratio among a first primary color, a second primary color, and a third primary color of the color cast image;
choosing one parameter group from a plurality of color cast calibration parameter groups according to the color temperature; and
calibrating the brightness ratio among the first primary color, the second primary color, and the third primary color of the color cast image via the chosen color cast calibration parameter group.

2. The method of eliminating a color cast of an image according to claim 1, wherein the step of analyzing the brightness ratio of the color cast image includes:
obtaining a first brightness ratio between the first primary color and the second primary color; and
obtaining a second brightness ratio between the third primary color and the second primary color.

3. The method of eliminating a color cast of an image according to claim 2, wherein the chosen color cast calibration parameter group includes:
a first calibration parameter used for calibrating the first brightness ratio; and
a second calibration parameter used for calibrating the second brightness ratio.

4. The method of eliminating a color cast of an image according to claim 1, wherein the first primary color is red, the second primary color is green, and the third primary color is blue.

5. The method of eliminating a color cast of an image according to claim 1, further comprising:
getting the color cast calibration parameter groups at different color temperatures.

6. The method of eliminating a color cast of an image according to claim 5, wherein the step of getting the color cast calibration parameter groups includes:
getting a plurality of with-color-cast calibration images of a color cast calibration component at different color temperatures;
analyzing a brightness ratio among the first primary color, the second primary color, and the third primary color of each of the with-color-cast calibration images;
getting a plurality of without-color-cast calibration images of the color cast calibration component at different color temperatures;
analyzing, the brightness ratio among, the first primary color, the second primary color, and the third primary color of each of the without-color-cast calibration images; and
comparing the brightness ratio between the with-color-cast calibration images and the without-color-cast calibration images according to different color temperatures to get the color cast calibration parameter groups, respectively.

7. The method of eliminating a color cast of an image according to claim 6, wherein the color cast calibration parameter groups at a same color temperature includes:
a first calibration parameter, wherein the first calibration parameter is in proportion to the brightness ratio between the first primary color and the second primary color of the without-color-cast calibration images, and the first calibration parameter is in inverse proportion to the brightness ratio between the first primary color and the second primary color of the with-color-cast calibration images; and
a second calibration parameter, wherein the second calibration parameter is in proportion to the brightness ratio between the third primary color and the second primary color of the without-color-cast calibration images, and the second calibration parameter is in inverse proportion to the brightness ratio between the third primary color and the second primary color of the with-color-cast calibration images.

8. The method of eliminating a color cast of an image according to claim 6, wherein the color cast calibration component is a grey card or a white card.

9. The method of eliminating a color cast of an image according to claim 6 farther comprising:
fitting a color cast calibration parameter group of a first color temperature and a color cast calibration parameter group of a second color temperature to get at least one color cast calibration parameter group between the first color temperature and the second color temperature.

10. The method of eliminating a color cast of an image according to claim 9, wherein the step of fitting is a linear fitting.
